(19) United States
(12) Patent Application Publication
(10) Pub. No.: US 2022/0328875 A1
(43) Pub. Date: Oct. 13, 2022

(54) ELECTROLYTE SOLUTION FOR LITHIUM SECONDARY BATTERY AND LITHIUM SECONDARY BATTERY INCLUDING THE SAME

(71) Applicants: Hyundai Motor Company, Seoul (KR); Kia Corporation, Seoul (KR); UNIST(ULSAN NATIONAL INSTITUTE OF SCIENCE AND TECHNOLOGY), Ulsan (KR)

(72) Inventors: Woo Young JIN, Busan (KR); Jun Ki RHEE, Suwon (KR); Yeol Mae YEO, Hwaseong (KR); Seung Min OH, Incheon (KR); Yoon Sung LEE, Suwon (KR); Ji Eun LEE, Hwaseong (KR); Sang Hun LEE, Paju (KR); Ko Eun KIM, Cheongju (KR); Sang Mok PARK, Gwangju (KR); Sung Ho BAN, Hwaseong (KR); Hyeon Gyu MOON, Ulsan (KR); Hui Beom NAM, Ulsan (KR); Hyun Soo MA, Ulsan (KR); Nam Soon CHOI, Ulsan (KR)

(21) Appl. No.: 17/532,078

(22) Filed: Nov. 22, 2021

(30) Foreign Application Priority Data
Apr. 1, 2021 (KR) 10-2021-0042802

(51) Int. Cl. H01M 10/0567; H01M 10/0569; H01M 10/0525

(52) U.S. Cl. CPC H01M 10/0567; H01M 10/0569; H01M 10/0525; H01M 2300/0042; H01M 2220/20

(57) ABSTRACT

Disclosed are an electrolyte solution and an additive thereof, which may increase electrochemical properties of a lithium secondary battery.

### CROSS REFERENCE TO RELATED APPLICATION

The present application claims priority to Korean Patent Application No. 10-2021-0042802, filed Apr. 1, 2021, the entire contents of which is incorporated herein for all purposes by this reference.

### TECHNICAL FIELD

The present invention relates to an electrolyte solution forming a lithium secondary battery and a lithium secondary battery including the electrolyte solution. The electrolyte solution additive may improve electrochemical properties of a lithium secondary battery.

### BACKGROUND

A battery is an energy storage source which may convert chemical energy into electric energy or electric energy into chemical energy. Batteries may be divided into non-reusable primary batteries and reusable secondary batteries. A secondary battery has an advantage of being environmentally friendly in that it is reusable, as compared with a primary battery which is used once and thrown away.

Recently, as an environmental issue has been raised, a demand for a hybrid electric vehicle (HEV) and an electric vehicle (EV) which cause less or no air pollution has been increasing. For example, EV from which an internal combustion engine is completely removed may set out a path for the world to go forward in the future.

For commercialization of EV, problems of a battery mounted in EV should be solved. The battery mounted in EV should allow traveling of 500 km or more on a single charge, have an output at a certain level or higher for using a high performance motor, and be charged at a high speed.

Accordingly, a lithium ion battery may have a high theoretical capacity and electromotive force of 4 V or greater, and is capable of fast charge and discharge.

The lithium secondary battery is largely formed of a positive electrode, a negative electrode, an electrolyte, and a separator. In the positive and negative electrodes, intercalation and deintercalation of lithium ions are repeated to generate energy, the electrolyte serves as a passage where lithium ions move, and the separator serves to prevent occurrence of a short circuit in the battery caused by a contact between the positive electrode and the negative electrode.

In particular, the positive electrode is closely related to a capacity of a battery, and the negative electrode is closely related to performance of a battery such as fast charge and discharge.

The electrolyte is formed of a solvent, an additive, and a lithium salt. The solvent serves as a passage to help lithium ions move between the positive electrode and the negative electrode. In order to have excellent performance of a battery, the lithium ions should be transferred rapidly between the positive electrode and the negative electrode. Therefore, it is a very important issue to select an optimal electrolyte for obtaining excellent battery performance.

In particular, in a formation process performed during the production of a battery, a thin film called a solid electrolyte interphase (SEI) is formed on the negative electrode. SEI is a film through which lithium ions may pass but electrons may not pass, and electrons are prevented from passing through SEI to derive a side reaction to deteriorate battery performance. In addition, the electrolyte and the negative electrode are prevented from reacting directly and the negative electrode is prevented from falling off.

An additive of the electrolyte is a material added in a trace amount, e.g., in an amount of 0.1 to 10% with respect to a weight of the electrolyte. Though added in a trace amount, performance and stability of the battery are greatly affected by the additive. In particular, the additive may derive SEI formation on the surface of the negative electrode and adjust an SEI thickness. In addition, the additive may prevent overcharge of the battery, and may increase conductivity of lithium ions inside the electrolyte.

In addition, though silicon (Si) attracts attention as a negative electrode active material due to its high theoretical capacity, it is difficult to commercialize the material due to various problems, for example, when insertion and desorption of lithium of a silicon-based negative electrode active material are repeated, the structure of the negative electrode active material becomes unstable due to contraction and expansion of a material, and an irreversible capacity is increased by a reaction with lithium, and thus, it is one of the main objects to develop an additive appropriate for the silicon-based negative electrode active material.

For the reasons described above, study and development for an additive included in the electrolyte are currently actively performed in the art.

The contents described as the related art have been provided only to assist in understanding the background of the present invention and should not be considered as corresponding to the related art known to those having ordinary skill in the art.

### SUMMARY

In preferred aspects, provided is an electrolyte solution additive which may be added to an electrolyte solution of a lithium secondary battery to improve electrochemical properties of the lithium secondary battery.

In an aspect, provided is an electrolyte solution for a lithium secondary battery that may include: an electrolyte salt and an organic solvent. Particularly, the electrolyte solution may include LiDFBP represented by the following Chemical Formula 1 and a compound represented by the following Chemical Formula 2 as an additive:

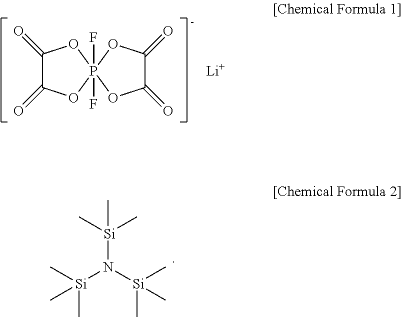

The electrolyte solution may suitably include the compound represented by Chemical Formula 2 in an amount of about 0.1 to 10 wt %, based on the total weight of the electrolyte solution.

The electrolyte solution may suitably include LiDFBP represented by Chemical Formula 1 in an amount of about 0.1 to 10 wt %, based on the total weight of the electrolyte solution.

The electrolyte salt may be one or more selected from the group consisting of LiPF₆, LiBF₄, LiClO₄, LiCl, LiBr, LiI, LiB₁₀Cl₁₀, LiCF₃SO₃, LiCF₃CO₂, Li(CF₃SO₂)₃C, LiAsF₆, LiSbF₆, LiAlCl₄, LiCH₃SO₃, LiCF₃SO₃, LiN(SO₂C₂F₅)₂, Li(CF₃SO₂)₂N, LiC₄F₉SO₃, LiB(C₆H₅)₄, and Li(SO₂F)₂N (LiFSI).

A concentration of the electrolyte salt may be about 0.5 M to 1.0 M.

The organic solvent may be one or more selected from the group consisting of carbonate-based solvents, ester-based solvents, ether-based solvents, and ketone-based solvents.

The lithium secondary battery may include a positive electrode, a negative electrode, a separator interposed between the positive electrode and the negative electrode, and the electrolyte solution of claim 1.

In a further aspect, a vehicle (including an electric-powered vehicle) is provided that comprises a an electrolyte solution as disclosed herein.

In a yet further aspect, a vehicle (including an electric-powered vehicle) is provided that comprises a battery as disclosed herein.

Other aspects of the invention are disclosed infra.

### BRIEF DESCRIPTION OF THE DRAWINGS

FIGS. 1 to 5 are graphs showing experimental results of discharge retention of Examples 1 to 15 according to exemplary embodiments of the present invention and Comparative Examples 1-5.

### DETAILED DESCRIPTION OF THE EMBODIMENTS

As described herein, objects, other objects, features, and advantages according to the present invention will be readily understood through the following preferred embodiments associated with the accompanying drawings. However, the present invention is not limited to the embodiments described herein and may also be embodied in other forms. Rather, the embodiments introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, a region, or a plate is referred to as being “above” the other portion, it may be not only “right above” the other portion, or but also there may be another portion in the middle. On the contrary, when a portion such as a layer, a film, a region, or a plate is referred to as being “under” the other portion, it may be not only “right under” the other portion, or but also there may be another portion in the middle.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, the present invention will be described in detail.

A lithium secondary battery generates heat during discharge and raises temperature with more use. The most optimal temperature of the lithium secondary battery is in a range of 15° C. to 40° C. Outside of the range, performance of the battery is decreased with the use of the battery.

When the battery is used at a low temperature, the activity of chemical materials is decreased to increase internal resistance of the battery, so that voltage is rapidly lowered and a discharge capacity is also rapidly decreased, and when the battery is used at a high temperature, the activity of chemical materials is increased, so that discharge of 100% or greater is done, and thus, an additional chemical reaction is caused to deteriorate and decrease the performance of the battery.

In particular, since Korea has four seasons, a battery having stable performance even at −40° C. to 60° C. should be provided so that EV is operated without a problem.

Thus, the battery has been tested under extreme conditions, and in particular, a high temperature life characteristic to allow a life characteristic to be maintained without deterioration even when the battery itself is used at a high temperature, is an important test item.

In addition, since HEV and EV require a higher output than a smart phone and a laptop, it is also an important test item how much discharge capacity the battery has at a rate determination of 1 C-rate or greater.

Meanwhile, complicated many chemical reactions occur inside a lithium secondary battery. The electrochemical properties of a battery may be maintained when among the chemical reactions, a reaction to deteriorate a battery is suppressed as much as possible. A particularly problematic one is HF. HF is produced by reaction of LiPF₆ which is a lithium salt and a trace amount of moisture in an electrolyte solution, and may destroy SEI formed on a negative electrode in an initial formation step and react with an active material in a positive electrode to elute metal ions of the active material.

Therefore, a HF-scavenger to remove HF which may be produced inside the electrolyte solution is needed in a lithium secondary battery.

In one aspect, an electrolyte solution for a lithium secondary battery for achieving the above object may include: an electrolyte salt and an organic solvent. In particular, the electrolyte solution may include LiDFBP represented by the following Chemical Formula 1 and may further include a compound represented by the following Chemical Formula 2 as an additive:

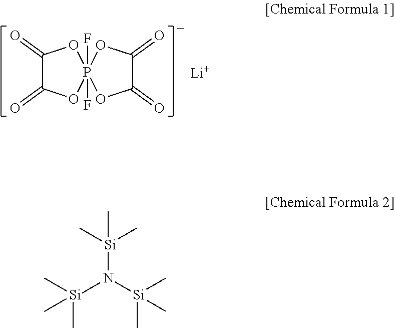

The material of Chemical Formula 2 is a compound which may be named as tris(trimethylsilyl)amine. The material may react with HF inside the lithium secondary batteiy to remove HF.

Hereinafter, results of an experiment for electrochemical properties of a lithium secondary battery manufactured using the additive will be described.

The lithium secondary battery of the present invention includes a positive electrode, a negative electrode, a separator interposed between the positive electrode and the negative electrode, and an electrolyte solution.

The positive electrode is formed by including an NCM-based positive electrode active material composed of Ni, Co, and Mn, and in particular, NCM811 was used in the present Example. As the positive electrode active material, LiCoO₂, LiMnO₂, LiNiO₂, LiNi₁₋ₓCoₓO₂, LiNi_{0.5}Mn_{0.5}O₂, LiMn₂₋ₓMₓO₄ (M is Al, Li, or transition metals), LiFePO, and the like may be used, and other positive electrode active materials which may be used in the lithium secondary battery may be all used.

The positive electrode may be formed by further including a conductive material and a binder.

The conductive material is used for imparting conductivity to an electrode and any conductive material may be used as long as it is an electroconductive material which does not cause a chemical change, in the battery to be configured. As an example, metal powder such as natural graphite, artificial graphite, carbon black, acetylene black, ketjen black, carbon fiber, copper, nickel, aluminum, and silver, metal fiber, and the like may be used, and also, conductive materials such as a polyphenylene derivative may be used alone or in combination of one or more.

A binder serves to attach active material particles to each other well or attach the particles to a current collector well, which is for mechanically stabilizing an electrode. The active material may be stably fixed in a process of repeating insertion and desorption of lithium ions, thereby preventing binding between the active material and the conductive material from being loose. The binder may preferably include a polymer including polyvinyl alcohol, carboxymethyl cellulose, hydroxypropyl cellulose, diacetyl cellulose, polyvinyl chloride, carboxylated polyvinyl chloride, polyvinyl fluoride, and ethylene oxide, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, and the like may be used, but the present invention is not limited thereto.

The negative electrode includes one or more of carbon (C)-based or silicon (Si)-based negative electrode active materials; as the carbon-based negative electrode active material, at least one material selected from the group consisting of artificial graphite, natural graphite, graphitized carbon fiber, graphitized mesocarbon microbeads, fullerene, and non-crystalline carbon, and as the silicon-based negative, any one material of SiOx and a silicon carbon complex system may be used. In particular, in the present embodiment, a graphite negative electrode active material was used.

The negative electrode may further include the binder and the conductive material like the positive electrode.

The electrolyte solution may be formed of an organic solvent and an additive.

The organic solvent may be one or more selected from the group consisting of carbonate-based solvents, ester-based solvents, ether-based solvents, or ketone-based solvents.

The carbonate-based solvent may include one or more selected from the group consisting of dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (FEC), and vinylene carbonate (VC). Further, as the ester-based solvent, γ-butyrolactone (GBL), n-methyl acetate, n-ethyl acetate, n-propyl acetate, and the like may be used, and as the ether-based solvent, dibutyl ether and the like may be used, but the present invention is not limited thereto.

The solvent may further include an aromatic hydrocarbon-based organic solvent. The aromatic hydrocarbon-based organic solvent may include benzene, fluorobenzene, bromobenzene, chlorobenzene, cyclohexylbenzene, isopropylbenzene, n-butylbenzene, octylbenzene, toluene, xylene, mesitylene, and the like, which may be used alone or in combination.

A separator prevents short circuit between the positive electrode and the negative electrode and provides a moving passage of lithium ions. As the separator, known ones, for example, a polyolefin-based polymer film such as polypropylene, polyethylene, polyethylene/polypropylene, polyethylene/polypropylene/polyethylene, and polypropylene/polyethylene/polypropylene films, or a multi-film thereof, a microporous film, woven fabric, and nonwoven fabric may be used. In addition, a film in which a resin having excellent stability is coated on a porous polyolefin film may be used.

### EXAMPLE

### Production and Experiment of Batteries Corresponding to Comparative Example and Example

Production of Positive Electrode

For production of a positive electrode, PVdF was dissolved in NMP to produce a binder solution.

A positive electrode active material and ketjen black used as a conductive material were mixed in the binder solution to produce a slurry, and the slurry was applied on both surfaces of an aluminum foil and dried.

Thereafter, a rolling process and a king process were performed, and an aluminum electrode was ultrasonically welded to produce a positive electrode. In the rolling process, the thickness was adjusted to 120 to 150 μm.

Here, as the positive electrode active material, Li₁₊ₓ[Ni_{0.8}Co_{0.1}Mn_{0.1}]O₂ (−0.5<x<0) which was a mixed material ofNi, Co, and Mn at 8:1:1 was used.

Production of Negative Electrode

A binder solution produced for production of a negative electrode and a negative electrode active material were mixed to produce a slurry, and the slurry was applied on both surfaces of an aluminum foil and dried.

Thereafter, a rolling process and a king process were performed, and a nickel electrode was ultrasonically welded to produce a negative electrode. In the rolling process, the thickness was adjusted to 120 to 150 μm.

As the negative electrode active material, graphite was used at this time.

Production of Electrolyte Solution

As an organic solvent, a mixture of ethylene carbonate (EC), ethylmethyl carbonate (EMC), and 1-ethoxy-2-methoxyethane (EME) at a volume ratio of 25:45:30 was used, and as a lithium salt, 0.5 M LiPF₆ and 0.5 M LiFSI were dissolved in a solvent and an electrolyte solution was injected. In addition, according to each Example, LiDFBP and tris(methyl)silylamine as an additive were added with different ratios to an organic solvent.

Production of Coin Cell

A separator was interposed between the positive electrode and the negative electrode, which was then wound to produce a jelly roll. The produced jelly roll and electrolyte solution were used to produce a coin cell.

### Comparative Example 1

DEC was used in the electrolyte solution instead of EME, and the battery did not include to LiDFBP and tris(methyl)silylamine additives.

### Comparative Example 2

The above electrolyte solution was used, and the battery did not include LiDFBP (hereinafter, referred to as additive 1) and tris(methyl)silylamine (hereinafter, referred to as additive 2) additives.

In Comparative Example 1 and Comparative Example 2, an experiment for evaluating the high temperature life of the produced batteries after 50 cycles was performed. In the measurement, a discharge termination voltage and a charge termination voltage were 2.5 V and 4.2 V, respectively, and a C-rate was 1.0 C. An experimental temperature was 45° C.

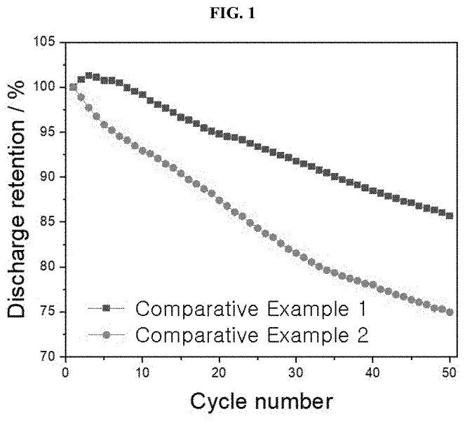

Experimental results are shown in the following Table 1, and the graph therefor is shown in FIG. 1.

TABLE 1

| | Solvent composition | | | | High temperature |
|---|---|---|---|---|---|
| | EC | EMC | DEC | EME | life (%) |
| Comparative Example 1 | 25 | 45 | 30 | — | 85.7 |
| Comparative Example 2 | 25 | 45 | — | 30 | 74.9 |

According to the above experimental results, as a result of repeating 50 cycles of charge and discharge, the high temperature life was shorter when EME was used than when DEC was used. However, ion mobility in the electrolyte was better when EME was used, due to the low viscosity of EME, than when DEC was used. Comparative Example 3 and Comparative Example 4 were the experiments showing the results.

### Comparative Example 3

The battery had the same composition as in Comparative Example 1.

### Comparative Example 4

The battery had the same composition as in Comparative Example 2.

In Comparative Example 3 and Comparative Example 4, an experiment for evaluating characteristics by rate of the produced batteries was performed. A discharge termination voltage and a charge termination voltage was 2.5 V and 4.2 V, respectively, and an experimental temperature was 25° C.

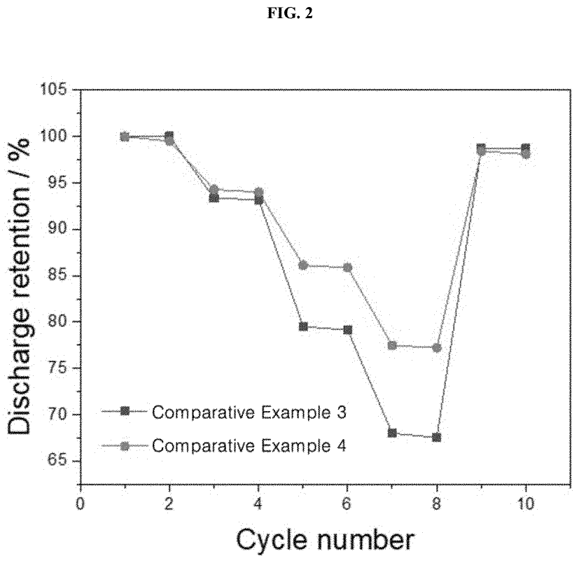

Experimental results are shown in the following Table 2, and the graph therefor is shown in FIG. 2.

TABLE 2

| | Solvent composition | | | | Characteristics by rate (%) | | |
|---|---|---|---|---|---|---|---|
| | EC | EMC | DEC | EME | 1 C | 2 C | 3 C |
| Comparative | 25 | 45 | 30 | — | 93.1 | 79.2 | 65.7 |
| Example 3 | | | | | | | |
| Comparative | 25 | 45 | — | 30 | 94.3 | 86.1 | 77.5 |
| Example 4 | | | | | | | |

According to the above experimental results, it is seen that the solvent using EME had better characteristics by rate than the solvent using DEC, and in particular, the difference was larger at a rate determination of 2 C or more. Since EMC has a lower viscosity than DEC, and ion movement is fast in a solvent by Stokes' law, the solvent using EME has a better rate determination characteristic. Accordingly, when EME was used instead of DEC, the characteristics by rate was increased, but the high temperature life was not good. Accordingly, it is the main test content whether the high temperature characteristic was improved while using EME.

### Comparative Example 5

The battery had the same composition as in Comparative Example 2.

### Example 4

The battery included 0.2 wt % of additive 2 in the composition of Comparative Example 2.

### Example 5

The battery included 0.5 wt % of additive 2 in the composition of Comparative Example 2.

### Example 6

The battery included 0.7 wt % of additive 2 in the composition of Comparative Example 2.

An experiment for evaluating the high temperature life of the batteries produced in Comparative Example 5, Example 4, Example 5, and Comparative Example 6 after 50 cycles was performed. In the measurement, a discharge termination voltage and a charge termination voltage were 2.5 V and 4.2 V, respectively, and a C-rate was 0.5 C. An experimental temperature was 45° C.

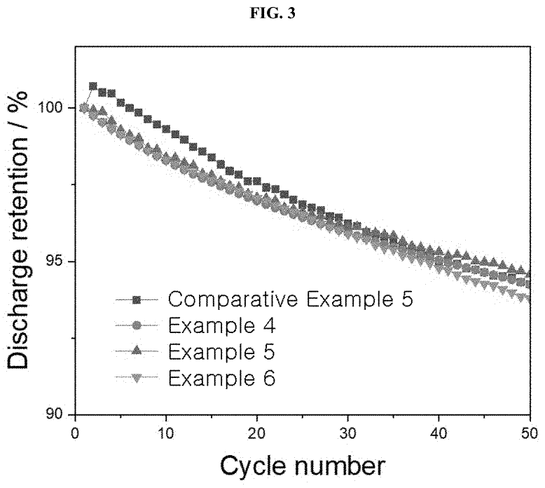

Experimental results are shown in the following Table 3, and the graph therefor is shown in FIG. 3.

TABLE 3

| | Solvent | | | | Additive | | High temperature |
|---|---|---|---|---|---|---|---|
| | EC | EMC | DEC | EME | Additive 1 | Additive 2 | life (%) |
| Comparative | 25 | 45 | — | 30 | — | — | 94.3 |
| Example 5 | | | | | | | |
| Example 4 | 25 | 45 | — | 30 | — | 0.2 | 94.2 |
| Example 5 | 25 | 45 | — | 30 | — | 0.5 | 94.6 |
| Example 6 | 25 | 45 | — | 30 | — | 0.7 | 93.8 |

According to the experimental results, when EME was used, the high temperature life was a little increased as compared with Comparative Example 5, with the use of 0.5 wt % of additive 2.

### Example 7

The battery included 0.2 wt % of additive 1 in the composition of Example 4.

### Example 8

The battery included 0.5 wt % of additive 1 in the composition of Example 5.

### Example 9

The battery included 0.7 wt % of additive 1 in the composition of Example 6.

An experiments for evaluating the high temperature life of the batteries produced in Example 7, Example 8, and Example 9 after 50 cycles were performed. In the measurement, a discharge termination voltage and a charge termination voltage were 2.5 V and 4.2 V, respectively, and a C-rate was 0.5 C. An experimental temperature was 45° C.

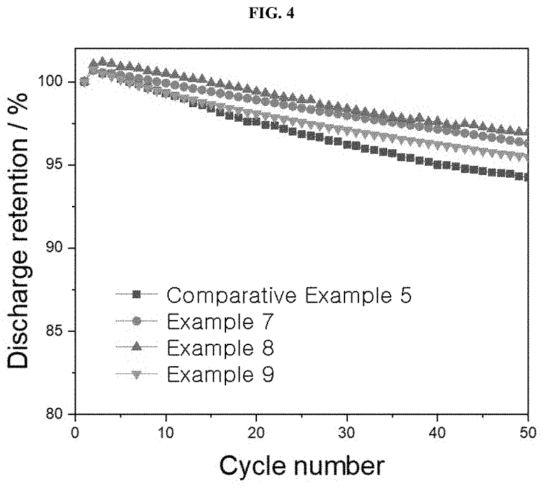

Experimental results are shown in the following Table 4, and the graph therefor is shown in FIG. 4.

TABLE 4

| | | | | | | | High |
|---|---|---|---|---|---|---|---|
| | Solvent | | | | Additive | | temperature |
| | EC | EMC | DEC | EME | Additive 1 | Additive 2 | life (%) |
| Comparative | 25 | 45 | — | 30 | — | — | 94.3 |
| Example 5 | | | | | | | |
| Example 7 | 25 | 45 | — | 30 | 0.2 | 0.2 | 96.3 |
| Example 8 | 25 | 45 | — | 30 | 0.5 | 0.5 | 96.9 |
| Example 9 | 25 | 45 | — | 30 | 0.7 | 0.7 | 95.5 |

According to the above experimental results, when additive 1 was further included, the high temperature life was greatly improved as compared with the case of only including additive 2.

### Example 13

The battery included 0.5 wt % of additive 1 in the composition of Comparative Example 2.

### Example 14

The battery included 0.5 wt % of additive 2 in the composition of Comparative Example 2.

### Example 15

The battery included 0.5 wt % of each of additives 1 and 2 in the composition of Comparative Example 2.

An experiments for evaluating the characteristics by rate of the batteries produced in Example 13, Example 14, and Example 15 were performed. In the measurement, a discharge termination voltage and a charge termination voltage were 2.5 V and 4.2 V, respectively, and a C-rate was 0.5 C. An experimental temperature was 25° C.

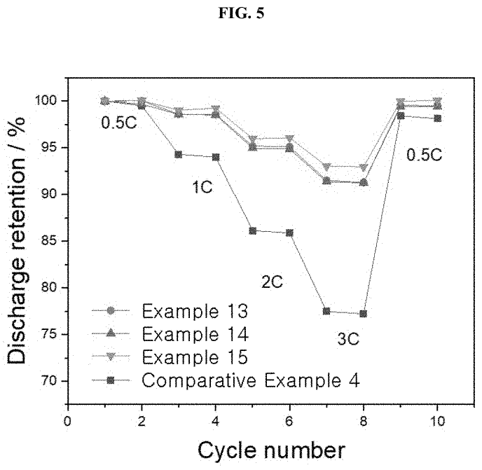

Experimental results are shown in the following Table 5, and the graph therefor is shown in FIG. 5.

TABLE 5

| | | | | | | | Characteristics | | |
|---|---|---|---|---|---|---|---|---|---|
| | Solvent composition | | | | Additive | | by rate (%) | | |
| | EC | EMC | DEC | EME | Additive 1 | Additive 2 | 1 C | 2 C | 3 C |
| Comparative | 25 | 45 | — | 30 | — | — | 94.3 | 86.1 | 77.5 |
| Example 4 | | | | | | | | | |
| Example 13 | 25 | 45 | — | 30 | 0.5 | — | 98.6 | 95.2 | 91.3 |
| Example 14 | 25 | 45 | — | 30 | — | 0.5 | 98.6 | 95.0 | 91.2 |
| Example 15 | 25 | 45 | — | 30 | 0.5 | 0.5 | 99.0 | 96.0 | 93.0 |

According to the above experimental results, the battery including both additive 1 and additive 2 had better characteristics by rate than the battery including only one of additive 1 and additive 2.

Accordingly, when DEC was used in the solvent, the high temperature life was better but the characteristic by rate was worse than when EME was used. Therefore, when additive 1 and additive 2 were mixed while using EME, the high temperature life may be improved and the characteristics by rate were also improved.

Each of the contents of the compounds of additives 1 and 2 may be 0.1 to 10 wt %, based on the total weight of the electrolyte solution, but is not necessarily limited to the range, and if necessary, an appropriate amount may be used.

In addition, the electrolyte salt may include the usable electrolyte salt at a concentration of 0.5 M to 1.0 M.

According to various exemplary embodiments of the present invention, because the lithium secondary battery including the additive may prevent HF from destroying SEI by tris(trimethylsilyl)amine included in an electrolyte solution, electrochemical performance of a battery may be substantially improved. In particular, when used with LiDFPB, an excellent life at high temperature of the battery and good characteristics are shown at a high speed rate determination.

Although the present invention has been shown and described with respect to specific embodiments, it will be apparent to those having ordinary skill in the art that the present invention may be variously modified and altered without departing from the spirit and scope of the present invention as defined by the following claims.

What is claimed is:

1. An electrolyte solution for a lithium secondary battery comprising:
an electrolyte salt and an organic solvent,
wherein the electrolyte solution comprises LiDFBP represented by the following Chemical Formula 1 and a compound represented by the following Chemical Formula 2 as an additive:

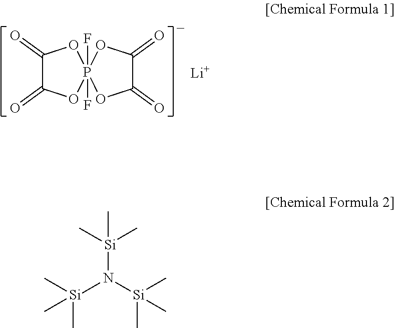

2. The electrolyte solution for a lithium secondary battery of claim 1, wherein the electrolyte solution comprises the compound represented by Chemical Formula 2 in an amount of about 0.1 to 10 wt %, based on the total weight of the electrolyte solution.

3. The electrolyte solution for a lithium secondary battery of claim 1, wherein the electrolyte solution comprises the LiDFBP represented by Chemical Formula 1 in an amount of about 0.1 to 10 wt %, based on the total weight of the electrolyte solution.

4. The electrolyte solution for a lithium secondary battery of claim 1, wherein the electrolyte salt comprises one or more selected from the group consisting of LiPF₆, LiBF₄, LiClO₄, LiCl, LiBr, LiI, LiB₁₀Cl₁₀, LiCF₃SO₃, LiCF₃CO₂, Li(CF₃SO₂)₃C, LiAsF₆, LiSbF₆, LiAlCl₄, LiCH₃SO₃, LiCF₃SO₃, LiN(SO₂C₂F₅)₂, Li(CF₃SO₂)₂N, LiC₄F₉SO₃, LiB(C₆H₅)₄, and Li(SO₂F)₂N (LiFSI).

5. The electrolyte solution for a lithium secondary battery of claim 1, wherein a concentration of the electrolyte salt in the electrolyte solution is about 0.5 M to 1.0 M.

6. The electrolyte solution for a lithium secondary battery of claim 1, wherein the organic solvent comprises one or more selected from the group consisting of carbonate-based solvents, ester-based solvents, ether-based solvents, and ketone-based solvents.

7. A lithium secondary battery comprising: a positive electrode, a negative electrode, a separator interposed between the positive electrode and the negative electrode, and an electrolyte solution of claim 1.

8. A vehicle comprising an electrolyte solution of claim 1.

9. A vehicle comprising a battery of claim 7.
